(19) United States
(12) Patent Application Publication
(10) Pub. No.: US 2026/0200218 A1
(43) Pub. Date: Jul. 16, 2026

(54) HIGH CONTAINMENT MULTI-LAYER STRETCH FILM FOR STRETCH HOOD AND METHOD OF MAKING SAME

(71) Applicants: Zachary Bobbitt, Longview, TX (US); Alain Akiki, Zouk Mosbeh (LB)

(72) Inventors: Zachary Bobbitt, Longview, TX (US); Alain Akiki, Zouk Mosbeh (LB)

(21) Appl. No.: 19/443,146

(22) Filed: Jan. 8, 2026

Related U.S. Application Data
(60) Provisional application No. 63/744,645, filed on Jan. 13, 2025.

(51) Int. Cl. B32B 27/32; B29C 48/00; B29C 48/10; B29C 48/21; B29K 23/00; B29K 105/00; B29L 7/00; B32B 27/08; B32B 27/18

(52) U.S. Cl. CPC B32B 27/32; B29C 48/0017; B29C 48/10; B29C 48/21; B32B 27/08; B32B 27/18; B29K 2023/0625; B29K 2105/0044; B29K 2995/0063; B29K 2995/0097; B29L 2007/00; B32B 2250/03; B32B 2250/05; B32B 2250/242; B32B 2250/40; B32B 2307/308; B32B 2307/72; B32B 2307/7376

(57) ABSTRACT

A multilayer film suitable for manufacturing a stretch hood used to secure palletized goods during shipment and transport. The multilayer film comprises at least three layers and includes a first layer comprising a linear low density polyethylene resin having a melt index within the range of 0.20 and 0.60 dg/min and a density within the range of 0.910 to 0.914 g/cm3, a second layer comprising a linear low density polyethylene resin having a melt index within the range of 0.20 and 0.60 dg/min and a density within the range of 0.910 to 0.914 g/cm3, and at least one intermediate layer in between the first and second layers, the intermediate layer or layers including a linear low density polyethylene resin having a fractional melt index and a thermoplastic polyolefin having a melt index within the range of 0.30 and 0.70 dg/10 min and a density within the range of 0.870 to 0.890 g/cm. The multilayer film having a total thickness between 4.85 and 6.7 mils and a density between 0.909 and 0.913 g/cm³. A stretch hood fabricated from such multilayer film exhibits exceptionally high holding force and, provides robust stability when utilized on palletized goods during transport. A method of manufacture of such multilayer film is also provided.

This application claims priority from U.S. Provisional Patent Application No. 63/744,645 filed on Jan. 13, 2025.

### FIELD OF THE INVENTION

This invention relates generally to multi-layer films and, more particularly, to multi-layer stretch hood films with enhanced holding force and elastic recovery.

### BACKGROUND

Stretch hoods are five sided tube-like covers, sealed at one end and open at the other, which are applied to palletized cargo and loads. These covers are typically formed from multi-layered blown films manufactured principally from linear low density polyethylene (LLDPE). Stretch hoods are, as their name implies, stretched over a palletized load and adhere to the load and pallet without the need for the application of heat. Ideally, a stretch hood securely holds a palletized load in place even when the load is subject to horizontal or vertical inertial forces during transport. A stretch hood should, therefore, provide adequate holding force and elastic recovery for one or more high trauma movements during the transport of secured cargo.

Safety has always been an important issue that must be considered during the transport of goods. In effort to increase the level of safety, and reduce injuries and fatalities associated with the transport of palletized loads, an increasing number of authorities are adopting stricter or more exacting requirements for transport packaging. A prime example of this may be found in the expanding acceptance and implementation of the European Safe Logistics Association (“EUMOS”) Standard 40509:2020 (“Standard 40509”) in conjunction with European Directive 2014/47/EU. Standard 40509 sets out a test method, to quantify the rigidity of a load unit when subject to certain inertial forces, in order to achieve compliance with Directive 2014/47/EU.

Stretch hoods for international transport should, therefore, comply with the minimum standards set forth in the foregoing regulations/directives, and similar regulations in other areas, to increase safety and to ensure that such stretch hoods can be used regardless of the location to which the goods travel. One current solution to achieve compliance with these types of requirements is to place multiple stretch hoods on the palletized load. Applying a second or even third stretch hood to a pallet increases the overall containment force on the load. While that may successfully secure the load and achieve the desired compliance, it increases the overall cost and adds time to the stretch hood application process.

Accordingly, there is a need for a multi-layer film from which a cost-effective stretch hood, offering the requisite level of holding force and elastic recovery to satisfy applicable safety standards, may be fabricated.

### SUMMARY OF THE INVENTION

A multilayer film suitable for manufacturing a stretch hood used to secure palletized goods during shipment and transport. The multilayer film comprises at least three layers and includes a first layer comprised of a linear low density polyethylene resin having a melt index within the range of 0.20 and 0.60 dg/min and a density within the range of 0.910 to 0.914 g/cm³, a second layer comprised of a linear low density polyethylene resin having a melt index within the range of 0.20 and 0.60 dg/min and a density within the range of 0.910 to 0.914 g/cm3, and at least one additional layer in between the first and second layers, this additional layer including a thermoplastic polyolefin having a melt index within the range of 0.30 and 0.70 dg/10 min and a density within the range of 0.870 to 0.890 g/cm³.

The film is manufactured using a blown film co-extrusion process wherein the blow-up ratio is maintained in a range between 3.0 and 3.6 and the draw down ratio is maintained in a range between 2.7 and 3.7 during the blown film process.

The multilayer film provides a holding force of at least 28 N which renders it most advantageous for fabrication of a stretch hood. A stretch hood fabricated from such film provides a cost-effective solution for increasing the containment level of palletized cargo during transport.

### BRIEF DESCRIPTION OF THE DRAWINGS

FIG. 1 is a diagram illustrating a conventional blown film manufacturing process.

### DETAILED DESCRIPTION

The present invention is a multilayer co-extruded blown film suitable for manufacturing a stretch hood to be used to secure goods during transport. The film functions well for this purpose, particularly in the form of a stretch hood for packaging heavy cargo which may be prone to shift during transport. A stretch hood made from this film possesses superior elastic recovery and a higher level of containment compared to prior art stretch hoods.

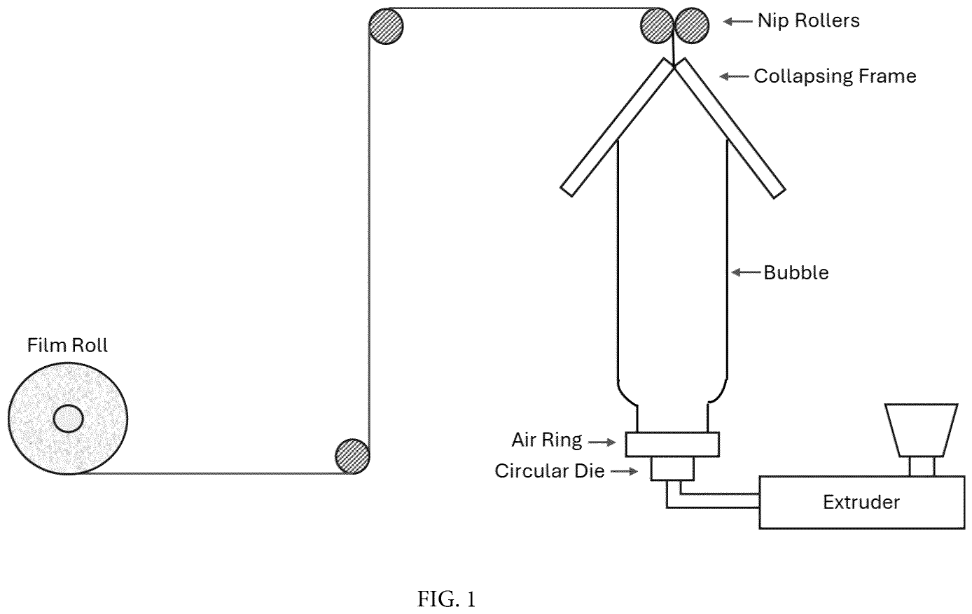

Conventional stretch hoods are formed from film fabricated through a blown film extrusion process well known in the art. For a stretch hood composed of a single layer film, plastic resin is extruded through a die and then blown with air and stretched to create a film as seen in FIG. 1. Multilayer-films are prepared through the addition of co-extrusion techniques to combine two or more polymer layers during the blown film process. Polyethylene, particularly linear low density polyethylene polymer (LLDPE), is the most common resin used to create blown films for stretch hoods. A conventional resin formulation for a three-layer stretch hood film is listed in Table 1.

TABLE 1

| Material (including common trade | First | Second | Third | Percentage of |
|---|---|---|---|---|
| designation(s) when applicable) | Layer | Layer | Layer | total film |
| XP7052ML (LLDPE) | n/a | 76.00% | n/a | 49.824% |
| Vistamaxx 6102FL | n/a | 20.00% | n/a | 13.112% |
| Antiblock | 2.00% | n/a | 2.00% | 0.689% |
| AG blend 20% UVI | 2.00% | 2.00% | 2.00% | 2.000% |
| (622/119) + 6% AO | | | | |
| Slip 2% Erucamide | 2.00% | 2.00% | 2.00% | 2.000% |
| Silicone-Free PPA | 2.00% | n/a | 2.00% | 0.689% |
| XUS 89770.03 (LLDPE) | 77.00% | n/a | 77.00% | 26.521% |
| XUS 59999.31 (LLDPE) | 15.00% | n/a | 15.00% | 5.166% |

The present invention utilizes a traditional blown film co-extrusion process to create a multi-layer film for stretch hoods but relies upon a novel combination of specific resins. Further, the manufacturing methodology incorporates certain critical manufacturing parameters.

More specifically, the resin used to manufacture the instant film relies upon lower flow resins that are not traditionally used to manufacture stretch hood films. These resins have a fractional melt index and a viscosity and density particularly selected to obtain the desired characteristics in a final stretch hood product. Moreover, certain parameters of the manufacturing process directly contribute to the ultimate properties of the stretch hood. Among others, the blow-up ratio (BUR) is targeted to the ideal point in the stretch-strain curve so that the final film provides a high level of containment force.

Generally, the film comprises at least three layers formed of resin compositions consisting principally of linear low density polyethylene. The total film thickness is in the range of 4.85 mils and 6.7 mils, or, more preferably 5.0 to 6.5 mils, and the total film density is in the range of 0.909 and 0.913 g/cm³.

The first set of preferred embodiments comprise a three layer film having a total film thickness of 6.5 mils. The first layer (layer A) having a thickness comprising 18% to 21% of the total film thickness, the second layer (layer B) having a thickness comprising 58% to 64% of the total film thickness, and the third layer (layer C) having a thickness comprising 18% to 21% of the total film thickness.

A first embodiment has specific thicknesses as follows: The first layer (layer A) having a thickness of 1.3 mils, the second layer (layer B) having a thickness of 3.9 mils, and the third layer (layer C) having a thickness of 1.3 mils. The respective volume, mass, and density of each layer, in relation to the total film, are reflected in Table 2.

TABLE 2

| Embodiment No. 1 | Layer A | Layer B | Layer C | Total film |
|---|---|---|---|---|
| Layer thickness | 1.3000 | 3.9000 | 1.3000 | 6.500 |
| Layer (%) Volume | 20.00% | 60.00% | 20.00% | 100% |
| Layer (%) Mass | 20.177% | 59.646% | 20.177% | 100% |
| Layer Density | 0.9194 | 0.9060 | 0.9194 | 0.9114 |

The layers of the film in this embodiment are formed of resin(s) having one or

more of the following components: a linear low density polyethylene (PE) having a fractional melt index, a PE/PP copolymer having a fractional melt index, antiblock additive, ultraviolet stabilizer, slip additive, and PFAS-free polymer processing aid. The principal component of each layer is the linear low density polyethylene having a fractional melt index which comprises at least ninety percent of the resin in layers A and C and seventy-five percent of the resin in layer B. Overall, this linear low density polyethylene comprises at least eighty percent of the total film material by weight. These resin formulations impart high holding properties for the stretch hood application that conventional resin formulations do not provide.

The percentage by weight of each resin component in this three-layer embodiment is a follows:

TABLE 3

| | Layer A: | Layer B: | Layer B: | Total |
|---|---|---|---|---|
| | Percentage of | Percentage | Percentage | Percentage |
| Material Type | Material | of Material | of Material | in Film |
| C-6 metallocene linear low | 91.00% | 76.00% | 91.00% | 82.053% |
| density polyethylene | | | | |
| Thermoplastic polyolefin | n/a | 20.00% | n/a | 11.929% |
| (Polyethylene Copolymer/ | | | | |
| Polypropylene copolymer) | | | | |
| Antiblock | 3.00% | n/a | 3.00% | 1.211% |
| Ultraviolet stabilizer | 2.00% | 2.00% | 2.00% | 2.000% |
| Slip Additive | 2.00% | 2.00% | 2.00% | 2.000% |
| SI-Free PPA | 2.00% | n/a | 2.00% | 0.807% |

It is critical that, in the first embodiment and all alternate three-layer embodiments, the melt index (MI) and density ranges for each resin component are within the range(s) set forth in Table 4.

TABLE 4

| | Melt Index Range | | | |
|---|---|---|---|---|
| | (190 C./2.16 kg pursuant | | Density Range | |
| | to ISO standard 1133-1) | | (g/cm³) | |
| Material Type | Min | Max | Min | Max |
| C-6 metallocene linear low density | 0.20 | 0.60 | 0.910 | 0.914 |
| polyethylene | | | | |
| Thermoplastic polyolefin (Polyethylene | 0.30 | 0.70 | 0.870 | 0.890 |
| Copolymer/Polypropylene copolymer) | | | | |
| Antiblock | 5.0 | 20.0 | 1.100 | 1.350 |
| Ultraviolet stabilizer | 5.0 | 20.0 | 0.918 | 0.940 |
| Slip Additive | 5.0 | 20.0 | 0.910 | 0.930 |
| SI-Free PPA | 5.0 | 20.0 | 0.919 | 0.929 |

A second set of embodiments comprises a five-layer film also having a total film thickness of 6.5 mils. Layers A and E (outside layers) having a thickness of 1.3 mils, Layer B having a thickness of 0.9750 mils, Layer C having a thickness of 1.950 mils and Layer D having a thickness of 1.300 mils. The respective volume, mass, and density of each layer, in relation to the total film, are reflected in Table 5.

TABLE 5

| Embodiment No. 2 | Layer A | Layer B | Layer C | Layer D | Layer E | Total film |
|---|---|---|---|---|---|---|
| Layer thickness | 1.3000 | 0.9750 | 1.9500 | 0.975 | 1.300 | 6.500 |
| Layer (%) Volume | 20.00% | 15.00% | 30.00% | 15.00% | 20.00% | 100% |
| Layer (%) Mass | 20.181% | 14.947% | 29.743% | 14.95% | 20.18% | 100% |

The layers of these second embodiments are formed from resins having one or more of the following components: a linear low density polyethylene (PE) and a PE/PP copolymer both having a fractional melt index, antiblock additive, ultraviolet stabilizer, slip additive, and PFAS-free polymer processing aid. The principal component of each layer is the linear low density polyethylene having a fractional melt index which comprises at least ninety percent of the resin for layers A and C and seventy-five percent of the resin for layer B. Overall, the linear low density polyethylene comprises at least eighty percent of the total film material by weight. The percentage by weight of each resin component in this embodiment is a follows:

TABLE 6

| | Layer | Layer | Layer | Layer | Layer | Total | Density |
|---|---|---|---|---|---|---|---|
| Material Type | A (%) | B (%) | C (%) | D (%) | E (%) | Percentage | (g/cm³) |
| C-6 metallocene | 91.00% | 82.00% | 68.00% | 82.00% | 91.00% | 81.469% | 0.912 |
| linear low density | | | | | | | |
| polyethylene | | | | | | | |
| Thermoplastic | n/a | 14.00% | 28.00% | 14.00% | n/a | 12.513% | 0.880 |
| polyolefin | | | | | | | |
| (Polyethylene | | | | | | | |
| Copolymer/ | | | | | | | |
| Polypropylene | | | | | | | |
| copolymer) | | | | | | | |
| Antiblock | 3.00% | n/a | n/a | n/a | 3.00% | 1.211% | 1.196 |
| Ultraviolet stabilizer | 2.00% | 2.00% | 2.00% | 2.00% | 2.00% | 2.000% | 0.930 |
| Slip Additive | 2.00% | 2.00% | 2.00% | 2.00% | 2.00% | 2.000% | 0.925 |
| SI-Free PPA | 2.00% | n/a | n/a | n/a | 2.00% | 0.807% | 0.926 |

Just as with the first embodiment disclosed above, the melt index and density ranges for each resin component in the second embodiment must be within the range(s) set forth in Table 3.

The following are two illustrative, non-limiting examples of three-layer and five layer film products produced according to the specification(s) set forth herein using commercially available polymers and additives:

### Example 1

A roll of three-layer stretch wrap film as set forth in the first embodiment. The standard trade designation of each component of the resin for each layer is set forth below. The respective percentages by weight and density of each component is also enumerated.

TABLE 7

| | | | | | Aggregate |
|---|---|---|---|---|---|
| | | | | Aggregate | Density |
| Material | Layer A | Layer B | Layer C | Percentage | (g/cm³) |
| XP7052ML | 91.00% | 76.00% | 91.00% | 82.053% | 0.912 |
| Lyondell Adflex Q 100 F | n/a | 20.00% | n/a | 11.929% | 0.880 |
| Antiblock | 3.00% | n/a | 3.00% | 1.211% | 1.196 |
| AG blend 20% UVI | 2.00% | 2.00% | 2.00% | 2.000% | 0.930 |
| (622/119) + 6% AO | | | | | |
| Slip 2% Erucamide | 2.00% | 2.00% | 2.00% | 2.000% | 0.925 |
| SI-Free PPA SCC94051 | 2.00% | n/a | 2.00% | 0.807% | 0.926 |

The LLDPE known by the trade name ExxonMobile® Exceed™ XP7052, or a substantial equivalent, is uniquely fit to the application as it provides higher holding force at lower thicknesses on average. Similarly, the copolymer known by the trade name Lyondell Bassell's Adflex Q100F may also be used as it presents higher holding force on average at the same core density. Further, due to both polymers' respective fractional melt index at their given densities, the propensity of the film to deflect at higher temperatures, inherent in container shipments, is much lower.

### Example 2

A roll of five-layer stretch wrap film as set forth in the second embodiment produced using commercially available components. The standard trade designation of each component of the resin for each layer is set forth below. Further the respective percentages by weight and density of each component is also identified.

TABLE 8

| | | | | | | Aggregate | Aggregate |
|---|---|---|---|---|---|---|---|
| | Layer | Layer | Layer | Layer | Layer | Percentage | Density |
| Material | A | B | C | D | E | of total film | (g/cm³) |
| XP7052ML | 91.00% | 82.00% | 68.00% | 82.00% | 91.00% | 81.469% | 0.912 |
| Lyondell Adflex Q | n/a | 14.00% | 28.00% | 14.00% | n/a | 12.513% | 0.880 |
| 100 F | | | | | | | |
| Antiblock | 3.00% | n/a | n/a | n/a | 3.00% | 1.211% | 1.196 |
| AG blend 20% UVI | 2.00% | 2.00% | 2.00% | 2.00% | 2.00% | 2.000% | 0.930 |
| (622/119) + 6% AO | | | | | | | |
| Slip 2% Erucamide | 2.00% | 2.00% | 2.00% | 2.00% | 2.00% | 2.000% | 0.925 |
| SI-Free PPA | 2.00% | n/a | n/a | n/a | 2.00% | 0.807% | 0.926 |
| SCC94051 | | | | | | | |

As noted above, the film disclosed herein is manufactured using a conventional blown film co-extrusion process which is well-known in the art. However, during the manufacturing process the blow-up ratio (BUR) (the ratio of the final diameter of the blown bubble relative to the die diameter) is maintained in a range having a minimum of 3.0 and a maximum of 3.6 in order to improve the film's elastic modulus. The draw down ratio (DDR) (the haul off speed divided by the polymer melt velocity) is maintained in a range between 2.7 and 3.7 during the process. These two parameters are critical to obtaining the desired physical and mechanical properties in the completed film. Maintaining the required range(s) contributes to the overall strength of the completed film, and, commensurately, the holding force when used to secure a load.

It will be noted that additional embodiments having more than five layers may also be produced. In each case, the MI and density of each resin component must be within the respective ranges set forth in Table 3. Further, the BUR and DDR values discussed above must be obtained and maintained during the manufacturing process.

A stretch hood fabricated from the film disclosed herein provides a greater holding force than that provided by a stretch hold fabricated from the prior art methodologies. The greater holding force directly translates to an increased level of containment of palletized cargo when that cargo is subject to inertial forces. Table 8 sets forth select characteristics of a stretch hood fabricated from the film disclosed herein as compared to the prior art.

TABLE 9

| | | | | Holding Force | Holding Force | Holding Force | Holding |
|---|---|---|---|---|---|---|---|
| | Elastic | Elastic | Elastic | (N) | (N) | (N) | Force |
| | Recovery | Recovery | Recovery | @ 70% | @ 85% | @ 100% | Increase |
| | % @70% | % @85% | % @100% | Elongation and | Elongation and | Elongation and | Over Prior |
| Blend | Elongation | Elongation | Elongation | 55% Recovery | 70% Recovery | 85% Recovery | Art |
| Prior | 97.60% | 90.02% | 83.87% | 16.73 | 17.17 | 16.46 | — |
| Art | | | | | | | |
| Ex. | 93.32% | 87.87% | 83.08% | 29.44 | 29.89 | 29.42 | 176% |
| No. 1 | | | | | | | |

As can be seen from the table, this embodiment of the film manifests a containment (holding force) in excess of 28 N. As a result, the application of a single stretch hood provides the same or greater level of containment as provided by two or more conventional stretch hoods.

By way of example, thermoplastic resin beads, e.g., packaged polyethylene or polypropylene beads, are typically shipped in bulk in bags or containers secured on pallets. Resin beads shipped in this manner, are usually shipped in a unform or standard manner, namely, 25 kilogram bags are stacked five bags per layer with up to twelve layers in total for a maximum of sixty bags per pallet. The maximum weight of the palletized load is typically 1600 kilograms, including the resin, pallet, and associated packaging.

A single stretch hood composed of the three-layer film disclosed herein, when applied to a conventional palletized load of resin bags as set forth in the prior paragraph, will provide a high level of containment for the cargo and will meet or exceed the three test evaluation criteria set forth in Sec. 5.3 of EUMOS Standard 40509:2020. Moreover, a stretch hood formed from the multilayer film disclosed herein will maintain a high holding force upon such cargo, and satisfy the EUMOS Standard. even after the film has been subject to a significant temperature variation during oversees transport of the goods.

Elastic recovery results, when referenced herein, were measured as follows: a 1″×5″ sample of film was put into universal tensile tester, the sample was stretched at 20 inches per minute to the determined initial elongation to match the stretch ratio applied to the film [40%, 60%, 80% or 100%], the film was held at this point for five seconds to match the process happening in the hood machine when the film is in use, and initial Holding Force was measured here and after 5 seconds. The film was then relaxed at 20 inches per minute for 20 seconds to best match the actual hooding process, the load cell was constantly measured during this time ensuring the film was not under stress (Chasing zero load on the load cell), the film was then re-stretched until 5N worth of pressure was applied (ensuring it wasn't further elongated but the film was taut). Permanent Deviation was determined by subtracting the initial film length from the film length after the test. Elastic recovery was then calculated as being equal to (Initial Film Length-Permanent Deviation)/Initial Film Length.

Holding force results, when referenced herein, were measured as follows: a 1″×5″ sample of film was put into universal tensile tester, the sample was stretched at 20 inches per minute to the determined initial elongation to match the stretch ratio applied to the film [40%, 60%, 80% or 100%], the film was held at that point for five seconds to match the process happening in the hood machine when the film is in use, and Initial Holding Force was measured and then measured again after five seconds. The film was then relaxed to the initial elongation-15% [e.g., 40% elongation to 25% elongation, 60% elongation to 45% elongation, etc.,], the film was held at this point for 60 seconds or until the load stabilized, and Final Holding Force was measured. All readings were in Newtons and measured at their appropriate times (Initial Holding Force, Released Holding Force, Final Holding Force.

It will be noted that the density and melt index of the polymers described herein were measured, when applicable, in accordance with the standards set forth in ASTM D-1505 and ASTM D-1238, respectively.

Other embodiments of the present invention will be apparent to those skilled in the art from consideration of the specification. It is intended that the specification and figures be considered as exemplary only, with the true scope and spirit of the invention being indicated by the claims.

What is claimed is:

1. A multilayer film suitable for use in fabricating a stretch hood comprising:
a first outer layer, a second outer layer, and a core layer between said first and second outer layers;
said first outer layer and said second outer layer comprising of between 90-93% by weight a linear low density polyethylene resin having a melt index within the range of 0.20 and 0.60 dg/10 min and a density within the range of 0.910 to 0.914 g/cm³;
said core layer comprising a thermoplastic polyolefin having a melt index within the range of 0.30 and 0.70 dg/10 min and a density within the range of 0.870 to 0.890 g/cm³; and,
said multilayer film having a total thickness between 4.85 mils and 6.7 mils and a density between 0.909 and 0.913 g/cm³.

2. The multilayer film of claim 1 wherein both said first outer layer and said second outer layer further include an antiblock agent.

3. The multilayer film of claim 2 wherein both said first outer layer and said second outer layer contain a silicone free polymer processing aid.

4. The multilayer film of claim 3 wherein all layers include a slip agent.

5. The multilayer film of claim 1 wherein the thickness of said film is 6.5 mils.

6. A multilayer film suitable for use as a stretch hood comprising:
a first layer comprising at least 90% by weight a linear low density polyethylene resin having a melt index within the range of 0.20 and 0.60 dg/min and a density within the range of 0.910 to 0.914 g/cm3;
a second layer comprising at least 90% by weight a linear low density polyethylene resin having a melt index within the range of 0.20 and 0.60 dg/10 min and a density within the range of 0.910 to 0.914 g/cm3;
at least one intermediate layer positioned between said first layer and said second layer; said at least one intermediate layer including a thermoplastic polyolefin having a melt index within the range of 0.30 and 0.70 dg/10 min and a density within the range of 0.870 to 0.890 g/cm3 and a linear low density polyethylene resin having a melt index within the range of 0.20 and 0.60 dg/10 min and a density within the range of 0.910 to 0.914 g/cm3; and,
wherein said multilayer film has a total thickness of between 4.85 and 6.7 mils.

7. The multilayer film of claim 6 wherein said at least one intermediate layer comprises three layers and said film comprises five layers in total.

8. The multilayer film of claim 7 wherein both said first layer and said second layer further include an antiblock agent and a slip agent.

9. The multilayer film of claim 8 wherein all said first layer and said second layer contain a silicone free polymer processing aid.

10. The multilayer film of claim 9 wherein the thickness of said film is 6.5 mils.

11. The multilayer film of claim 6 wherein said film comprises at least six layers in total.

12. A method for producing a multilayer film suitable for use in fabricating a stretch hood comprising the steps of:
preparing a first polymeric component comprising at least 90% by weight a linear low density polyethylene (LLDPE) having a density of 0.910 to 0.914 g/cm³ and a melt index of 0.2 to 0.6 g/10 min;
preparing a second polymeric component comprising a polyethylene or polypropylene copolymer having a melt index within the range of 0.30 and 0.70 dg/10 min and a density within the range of 0.870 to 0.890 g/cm³ and a linear low density polyethylene (LLDPE) having a density of 0.910 to 0.914 g/cm³ and a melt index of 0.3 to 0.6 g/10 min;
preparing a third polymeric component comprising at least 90% by weight a linear low density polyethylene (LLDPE) having a density of 0.910 to 0.914 g/cm³ and a melt index of 0.2 to 0.6 g/10 min;
using a coextrusion process to extrude said first, second, and third polymeric components through an annular die to form a molten tube;
blowing said molten tube to form a blown film structure while maintaining a blow-up ratio for the film within the range of 3.0 to 3.6; and,
collapsing the film and collecting said film on one or more winders while maintaining a draw down ratio for the film in the range of 2.7 to 3.7.

13. The method of claim 12 wherein said first polymeric component and said third polymeric component each further include an antiblock agent, an ultraviolet stabilizer, a silicone free polymer processing aid, and a slip agent.

14. The method of claim 13 wherein said second polymeric component further includes an ultraviolet stabilizer and a slip agent.

15. The method of claim 12 further comprising:
preparing a fourth polymeric component and fifth polymeric component; each of said fourth and fifth polymeric components comprising a polyethylene or polypropylene copolymer having a melt index within the range of 0.30 and 0.70 dg/10 min and a density within the range of 0.870 to 0.890 g/cm3 and a linear low density polyethylene (LLDPE) having a density of 0.910 to 0.914 g/cm3 and a melt index of 0.2 to 0.6 g/10 min; and,
using said coextrusion process to extrude said first, second, third, fourth and fifth polymeric components through the annular die to form said molten tube.

16. The method of claim 12 wherein the multilayer film has a thickness of 4.85 and 6.7 mils.

17. The method of claim 16 wherein the multilayer film has a thickness of 5.0 and 6.5 mils.

18. The method of claim 17 wherein the multilayer film has a thickness of 6.5 mils.
